(19) United States
(12) Patent Application Publication
(10) Pub. No.: US 2007/0063367 A1
(43) Pub. Date: Mar. 22, 2007

(54) Devices and methods for evaluating alignment of an end of arm tool and a molding apparatus

(76) Inventors: Michael W. Litwin, Jacksonville, FL (US); Jeffrey Youngblood, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/224,188

(22) Filed: Sep. 12, 2005

(51) Int. Cl. B29C 45/76; B29C 45/00

(52) U.S. Cl. 264/40.1; 425/808; 425/567

(57) ABSTRACT

A preferred method for evaluating alignment of a molding apparatus and an end of arm tool includes placing a fixture on a surface of the molding apparatus so that a first and a second portion of the fixture become disposed in a respective first and second cavity of the molding apparatus, and determining whether a first and a second cup of the fixture can receive a respective first and second pickup of the end of arm tool if the end of arm tool is moved toward the fixture.

### FIELD OF THE INVENTION

The present invention relates generally to molding operations, such as injection molding. More particularly, the invention relates to devices and a methods for evaluating the alignment of a molding apparatus, such as a mold, and an end of arm tool used to transfer molded pieces to or from the molding apparatus.

### BACKGROUND OF THE INVENTION

Soft contact lenses are typically formed using a two-piece mold composed of a front curve and a back mold half. The front and back mold halves are positioned so that they are spaced apart in a predetermined relationship. A monomeric material in liquid form is introduced into the gap between the front and back mold halves. The monomeric material, upon curing, forms the contact lens. The molding surface of each of the front and back mold halves are configured to shape the lens in a particular manner, so that the lens possesses optical properties that produce a desired vision correction in the end user.

The front and back mold halves are typically formed by injection molding. Once formed, the front and back mold halves are removed from the mold and transferred to the production line. Alternatively, the contact lenses may be stored until needed in the production operation.

The relatively large production volumes of a typical contact lens production operation requires that front and back mold halves be manufactured on a nearly continuous basis. For example, in some production operations, one set of eight front and back mold halves is manufactured every two and one-half to three seconds. This rate of production requires that the newly-formed front and back mold halves be transferred from the mold relatively quickly.

Transfer of the front and back curves from the mold is typically accomplished using a robotic arm, and an end of arm tool (“EOAT”) mounted on the arm. The EOAT is equipped with an array of vacuum pickups for gripping a set of the front and back mold halves.

The front and back mold halves are usually formed within cavities in the in injection molding mold. The arm moves the pickup array to a position at which each pickup is positioned above an associated cavity. The arm lowers the EOAT so that the pickups each come into contact with, and grip a front or back curve. The arm the raises the EOAT so that the front and back mold halves are lifted from the cavities. The arm subsequently rotates to position the EOAT and the pickups over a carryover inlay nest or other device suitable for receiving the front and back mold halves. The arm then lowers the EOAT so that the front and back mold halves can be positioned on the carryover inlay nest and released from their associated pickups.

The small size of the front and back mold halves requires relatively close alignment of the pickups and the front and back mold halves as the pickups come into contact with their associated front and back mold halves. For example, the pickups and the mold cavities that hold the front and back curves may need to be aligned to within +/−1.0 millimeter. Substantial misalignment can result in frequent misfeeds of the front and back mold halves, and an attendant decrease in the throughput of the production process.

The EOAT, its attached pickups and the mold are usually aligned during the initial set up of the robotic arm. Due to its criticality, the alignment is usually checked on a period basis thereafter, or when misfeeds or other malfunctions begin to occur with a particular frequency.

The alignment of the EOAT and the mold is usually evaluated and adjusted based on sight or based on a visual observation of the relative positions of the pickups and their associated cavities in the mold. The visual observation is usually made by a technician or other individual servicing the arm and the EOAT. This technique may not produce the requisite degree of alignment precision for a number of reasons. For example, the relatively small size of the pickups in relation to the surface of the mold can make it difficult to precisely align the pickups and their associated cavities. Moreover, this alignment technique relies on a subjective judgment on the part of the technician.

The EOAT and the mold can also be aligned using special tooling. In particular, the production EOAT can be removed from the arm and replaced with specially designed aluminum alignment pieces. The production mold can likewise be removed and replaced with a specially-designed mold tool. The alignment pieces are configured to fit within the mold tool when the arm is properly positioned so that the production EOAT and mold, when replaced, will be in a state of alignment. The replacement of the production EOAT and mold with the special tooling required to perform this alignment technique can require substantial time and effort, and can result in substantial interruptions in the production process.

Consequently, a need exists for a device and a method for closely aligning an end of arm tool with a mold, without substantially interrupting production operations.

### BRIEF DESCRIPTION OF THE DRAWINGS

For the purpose of illustrating the invention, the drawings show an embodiment that is presently preferred. The invention is not limited, however, to the specific instrumentalities disclosed in the drawings. In the drawings:

FIG. 1 is a top view of a preferred embodiment of a fixture for evaluating alignment of a molding apparatus and an end of arm tool;

FIG. 2 is a cross-sectional side view of the fixture shown in FIG. 1, taken through the line “A-A” of FIG. 1;

FIG. 3 is a top perspective view of the fixture shown in FIGS. 1 and 2;

FIG. 4 is a bottom perspective view of the fixture shown in FIGS. 1-3;

FIG. 5 is a side view of the fixture shown in FIGS. 1-4, depicting the fixture in use to align a mold and an end of arm tool;

FIG. 6 is a side cross-sectional side view of the fixture, the mold, and the end of arm tool shown in FIGS. 1-5,

FIG. 7 is a top view of an injection molding system comprising the fixture, the mold, and the end of arm tool shown in FIGS. 1-6, an arm for supporting and moving the end of arm tool, and a carryover inlay nest for receiving front and back curves made in the mold;

FIG. 8 is a side view of a back curve that can be formed using the mold depicted in FIGS. 6 and 7;

FIG. 9 is a top view of an alternative embodiment of the fixture shown in FIGS. 1-7;

FIG. 10 is a top view of another alternative embodiment of the fixture shown in FIGS. 1-7;

FIG. 11 is a top view of another alternative embodiment of the fixture shown in FIGS. 1-7;

FIG. 12 is a top view of another alternative embodiment of the fixture shown in FIGS. 1-7; and

FIG. 13 is a top view of another alternative embodiment of the fixture shown in FIGS. 1-7.

### DETAILED DESCRIPTION OF ILLUSTRATIVE EMBODIMENTS

The invention provides methods and devices for evaluating an alignment of an end of arm tool and a molding apparatus by determining whether pickups of the end of arm tool can be received by cups of the devices when the devices are disposed on the molding apparatus.

In one embodiment, the invention provides a fixture comprising, consisting essentially of and consisting of a web portion and a first and a second cup attached to the web portion. The first and second cups each have a portion capable of being received in respective first and second cavities formed in a molding apparatus. The first and second cups each define a volume for receiving respective first and second pickups of an end of arm tool. A center to center spacing of the first and second cups is substantially equal to a center to center spacing of the first and second cavities so that the portions of the first and second cups can be received by the respective first and second cavities, and the first and second pickups can be received by the volumes defined by the respective first and second cups only when the end of arm tool is substantially aligned with the molding apparatus.

In a second embodiment, the invention provides methods for evaluating alignment of a molding apparatus and an end of arm tool comprising, consisting essentially of and consisting of placing a fixture on a surface of the molding apparatus so that a first and a second portion of the fixture become disposed in a respective first and second cavity of the molding apparatus, and determining whether a first and a second cup of the fixture can receive a respective first and second pickup of the end of arm tool if the end of arm tool is moved toward the fixture.

In a third embodiment, the invention provides methods for positioning an arm of an injection molding system comprising, consisting essentially of and consisting of placing a fixture on a surface of a mold of the injection molding system so that a first and a second projection of the fixture extend into a respective first and second cavity formed in the mold, and adjusting a position of the arm in relation to the mold until a first and a second pickup of an end of arm tool mounted on the arm can each enter a volume defined by the respective first and second cups without substantial interference between the first and second pickups and the respective first and second cups.

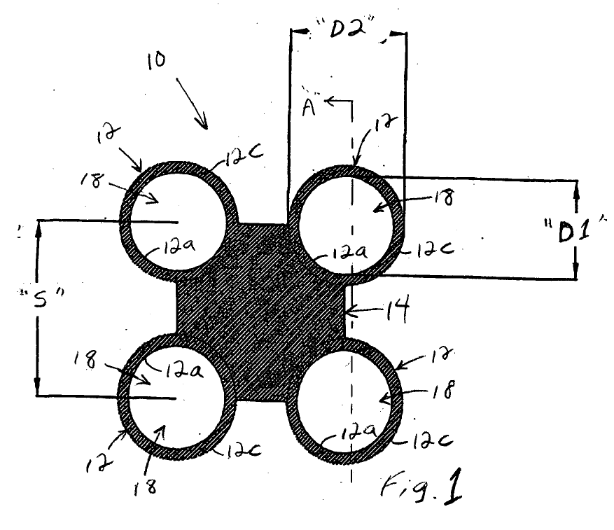

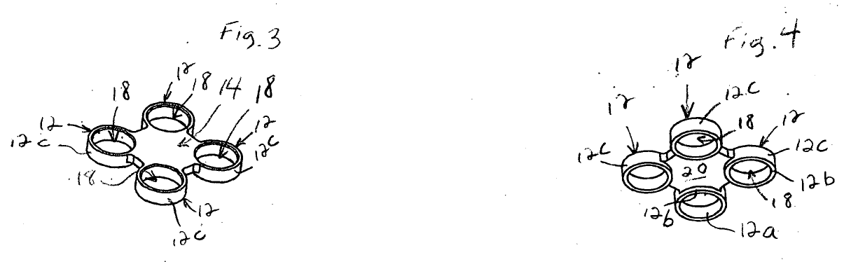

FIGS. 1-7 depict a preferred embodiment of a fixture 10. The fixture 10 can be used to align an end effector, or end of arm tool (EOAT) 106 with a molding apparatus such as a mold 104.

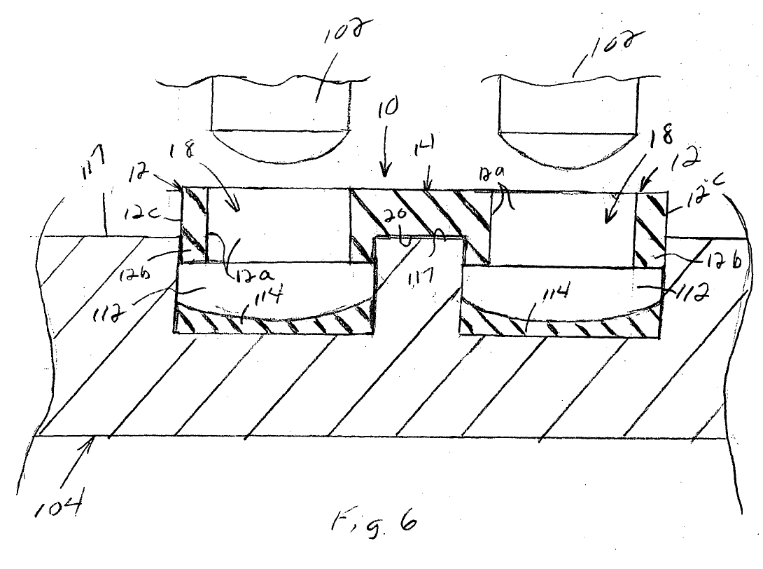

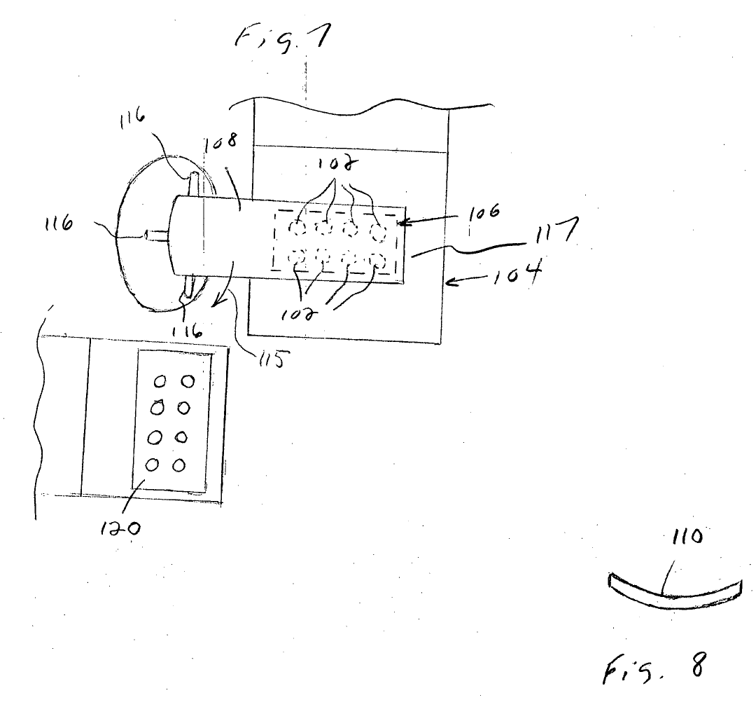

The mold 104 is used to form front and back mold halves 110 by injection molding (see FIG. 8). The mold 104 has a plurality of cavities 112 formed therein (see FIG. 6). Each cavity 112 accepts a mold half insert 114. The mold half insert 114 helps to form the associated front or back mold half 110 into a desired shape. The desired shape of the front or back mold half 110 is determined by the desired optical properties of the contact lens that the front or back mold half 110 will subsequently be used to manufacture.

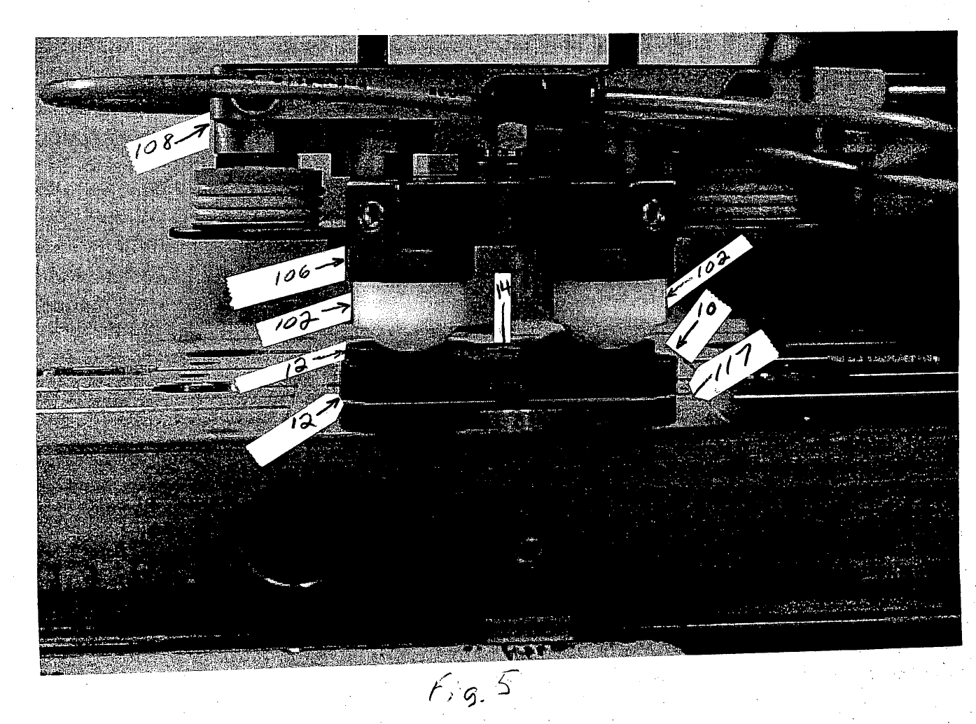

The EOAT 106 is mounted on an end of a robotic arm 108 as shown in FIGS. 5 and 7. The EOAT 106 includes eight suction cups, or vacuum pickups 102 arranged in two rows. The arm 108 articulates in the direction denoted by the arrow 115 in FIG. 7, to bring the pickups 102 into contact with the newly-formed front and back mold halves 110 in the mold 104.

The pickups 102 are in fluid communication with a vacuum source (not shown). Each pickup 102 includes vacuum ports that allow the pickup 102 to grip an associated front or back mold half 110 by way of a suction force generated by the vacuum source.

The arm 108 can lift the EOAT 106 and the attached front and back mold halves 110, to remove the front and back mold halves 110 from their associated cavities 112 in the mold 104. (The eight cavities 112 serviced by the EOAT 106 can be used, for example, to form four front curves 110 and four back mold halves 110.)

The arm 108 can then rotate approximately ninety degrees to position the EOAT 106 and the front and back mold halves 110 over a carryover inlay nest 120 (or other suitable device for receiving the front and back mold halves 110) (see FIG. 7). The arm 108 can subsequently lower the EOAT 106 and the attached front and back curves 110 so that the front and back mold halves 110 are positioned on the carryover inlay nest 120, and released from the pickups 102. The front and back mold halves 110 can then be conveyed or otherwise transported on the carryover inlay nest 120 to another location in the production facility.

Specific details concerning the structure and operation of the EOAT 106, the arm 108, and the mold 104 are presented for exemplary purposes only. The fixture 10 can be used in connection with other types of end of arm tools, robotic arms, and molds. Moreover, the fixture 10 can be employed in connection with molds used to form objects other than front and back mold halves.

The device 10 preferably has four substantially cylindrical cups 12, and a centrally-located web portion 14 adjoining each of the cups 12, as shown in FIGS. 1-4. The device 10 can be unitarily formed, using a suitable process such as injection molding. The device 10 is preferably formed from a relatively soft material, such as DuPont DELRIN®, to help minimize the potential for the device to scratch the mold 104.

Each cup 12 has an inner circumferential surface 12a. The inner circumferential surface 12a defines a volume 18 within the cup 12. The upper and lower ends of the volume 18 are open.

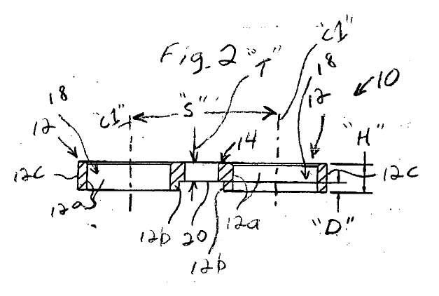

Directional terms such as “upward,” “downward,” “top,” “bottom,” “above,” “below,” and the liketh reference to the component orientations depicted in FIG. 2. These terms are used for illustrative purposes only, and are not meant to limit the scope of the appended claims.

The cup 12 has a diameter “D1” defined by an inner circumferential surface 12a of the cup 12 (see FIG. 1). The diameter D1 is preferably chosen so that one of the pickups 102 can be positioned within the volume 18, with minimal clearance between the inner circumferential surface 12a and the outer periphery of the pickup 102. For example, the diameter D1 can be approximately 17.200 mm (0.67717 inch). A diameter D1 of this value will result in a nominal clearance of approximately 0.1 mm (0.004 inch) between the inner circumferential surface 12a and the outer periphery of the pickup 102.

Specific dimensions for the fixture 10 are presented for exemplary purposes only. The dimensions of the fixture 10 are application-dependent, since the dimensions of the fixture 10 are tailored to the dimensions of the particular pickups 102 and mold 104 with which the fixture 10 is intended for use.

The cups 12 have a height “H” greater than a thickness “T” of the web portion 14 (see FIG. 2). In other words, a lower portion 12b of each cup 12 projects downward in relation to the web portion 14, as shown in FIGS. 2, 4, and 6. The distance by which the lower portion 12b projects downwardly in relation to a lower surface 20 of the web 14 is denoted by the reference character “D” in FIG. 2. This feature permits the lower portion 12b of each cup 12 to be received by a corresponding cavity 112 in the mold 104.

For example, the height H can be approximately 10.000 mm (0.39370 inch), and the thickness T can be approximately 8.0000 mm (0.31496 inch). Hence, the downward projection D of the lower portion 12b can be approximately 2.000 mm (0.078740 inch).

Each cup 12 has an outer circumferential surface 12c. The portion of the outer circumferential surface 12c associated with the lower portion 12b extends continuously around the lower portion 12b, as shown in FIG. 4. The lower portion 12b has an outer diameter “D2” defined by the outer circumferential surface 12c (see FIG. 1).

The diameter D2 is preferably chosen so that minimal clearance exists between the outer circumferential surface 12c and the periphery of the cavity 112, when the lower portion 12b is inserted into to the cavity 112 as shown in FIG. 6. For example, the outer diameter D2 can be approximately 20.900 mm (0.82283 inch). A diameter D2 of this value will result in a nominal clearance of approximately 0.1 mm (0.004 inch) between the outer circumferential surface 12c and the periphery of the cavity 112.

The cups 12 are depicted as being cylindrically-shaped to match the shape of the cavities 112 and the pickups 102. Alternative embodiments of the fixture 10 can include cups having different shapes, e.g., square or rectangular, to match the shape of the cavities and pickups with which the fixture is intended to be used.

The device 10 can be used to evaluate the alignment of four of the pickups 102 with four of the cavities 112. (As the relative positions of the eight pickups 102 on the EOAT 106 are fixed, and the relative positions of the cavities 112 on the mold 104 likewise are fixed, aligning four of the pickups 102 with four of the cavities 112 aligns all eight of the pickups 102 with their associated cavities 112.)

The positional relationship between adjacent cups 12 is substantially identical to the positional relationship between adjacent pickups 102, and between adjacent cavities 112 in the mold 104. In other words, the center to center spacing “S” between adjacent cups 12, i.e., the spacing between the centerline “C1” of adjacent cups 12, is approximately the same as the center-to-center spacing between adjacent pickups 102, and between adjacent cavities 112 (see FIG. 2). For example, the spacing S can be approximately 30.000 mm (1.1811 inch).

The fixture 10 can be used to align the EOAT 106 and the mold 104, or to verify that the mold 104 and the EOAT 106 are properly aligned, as follows. The fixture 10 can be positioned over the mold 104, so that the lower portions 12b of the four cups 12 are each aligned with a respective one of the cavities 112. (As the center to center spacing S of the cups 12 is substantially identical to the center to center spacing of the cavities 112, the cups 12 can be aligned with four of the cavities 112 on a simultaneous basis.)

The fixture 10 can then be lowered so that the lower portions 12b each drop into a respective cavity 112, until the bottom surface 20 of the web portion 14 contacts an upper surface 117 of the mold 104 as shown in FIG. 6. Each lower portion 12b extends into its associated cavity 112 by the distance D, i.e., by approximately 2.000 mm (0.78740 inch), at the point the bottom surface 20 contacts the upper surface 117.

Each lower portion 12b is sized to fit within the associated cavity 112 with minimal clearance between the outer circumferential surface 12c, and the periphery of the cavity 112, as discussed above. Hence, inserting the lower portions 12b into the associated cavities 112 substantially fixes the position of the fixture 10 in relation to the mold 104.

The fixture 10 is preferably positioned on the mold 104 so that two of the lower portions 12b are disposed in two of the outermost cavities 112, i.e., the cavities 112 closest to the edge of the mold 112, as shown in FIG. 5. Positioning the fixture 10 in this manner can help ensure that the user has the best possible visual perspective of the positional relationship between the pickups 102 and the fixture 10.

The EOAT 106 can subsequently be brought into proximity with the fixture 10. More particularly, the arm 108 can be activated, or manipulated manually, to bring each pickup 102 into proximity with an associated one of the cups 12, as depicted in FIGS. 5 and 6.

The pickups 102 can be lowered into their associated cups 12, if it appears that the pickups 102 are aligned with their associated cups 12, i.e., if it appears that each pickup 102 will drop into the volume 18 in its associated cup 12 without substantially contacting the cup 12. The center to center spacing S of the cups 12 is substantially identical to the center to center spacing between the pickups 102, as noted above. Moreover, the diameter D1 of each cup 12 is sized so that the cup 12 can receive an associated pickup 102 with minimal clearance therebetween. Hence, the ability of each cup 12 to receive its associated pickup 102 indicates that the EOAT 106 is properly aligned with the mold 104.

The position of the EOAT 106 in relation to the mold 104 can be adjusted, if it appears that the pickups 102 will not drop into their respective cups 12 when the EOAT 106 is lowered, i.e., it if appears that the pickups 102 will substantially contact the fixture 10 as the EOAT 106 is lowered.

The position of the EOAT 106 in relation to the mold 104 can be adjusted by adjusting the position of the arm 108. More particularly, the arm 108 is configured to stop upon reaching a predetermined position in relation to the mold 104, so that the EOAT 106 can be lowered to pick up the front and back mold halves 110. This position can be adjusted using features, such as turnbuckles 116, on the arm 108 (see FIG. 7). The position of the arm 108 can be adjusted until it appears that the pickups 102 are aligned with their respective cups 12.

The EOAT 106 can be lowered after the positional adjustment has been performed, so that the pickups 102 become disposed within the volume 18 within their associated cups 12. Further adjustments can be performed, if needed, until each pickup 102 moves into the volume 18 in its associated cup 12 without substantially contacting the cup 12.

The EOAT 106 and the mold 104, it is believed, can be aligned more precisely when the fixture 10 is used in lieu of alignment techniques performed on an exclusively visual basis. More precise alignment of the EOAT 106 and the mold 104 can potentially reduce the frequency of misfeeds during production of the front and back curves 110, thereby improving the throughput of the production process.

It is believed that the set-up time for the EOAT 106 and the arm 108 can be reduced by using the fixture 10 to conduct the alignment process, in comparison to other alignment techniques. Moreover, the number of iterations needed to obtain satisfactory alignment of the EOAT 106 and the mold 104 can potentially be reduced when using the fixture 10 to align the EOAT 106 and the mold 104.

Moreover, the reception of the pickups 102 by the cups 12 when the EOAT 106 and the mold 104 are aligned provides a positive, objective indication that the EOAT 106 and the mold 104 are aligned. Alignment performed on a strictly visual basis, by contrast, relies on the subjective judgment of the individual performing the alignment.

The fixture 10 can be installed without removing or disassembling the EOAT 106 or the mold 104, and without the use of any tooling or additional parts. Hence, the time, effort, and delays associated with removing the production EOAT 106 and mold 104, and installing specially designed alignment equipment in lieu thereof can be avoided through the use of the fixture 10.

The fixture 10 can also be used to align the EOAT 106 with the carryover inlay nest 120, using substantially the same technique discussed above in relation to the mold 104. The term “molding apparatus,” as used in the specification and claims, is intended to encompass carryover inlay nests such as the carryover inlay nest 120, in addition to molds such as the mold 104.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

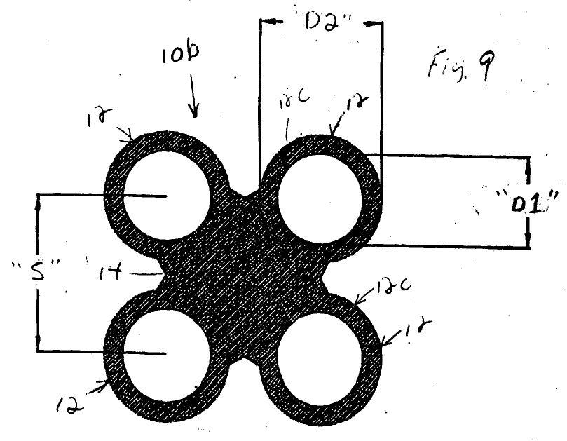

For example, FIG. 9 depicts an alternative embodiment of the fixture 10 in the form of a fixture 10a. The fixture 10a is substantially identical to the fixture 10, with the exception that the outer diameter D2 of the lower portion 12b is sized to fit mold cavities (not shown) having a larger diameter than the cavities 112 of the mold 104. In particular, the outer circumferential surface 12c is sized so that the outer diameter D2 of the lower portion 12b is approximately 24.300 mm (0.95669 inch).

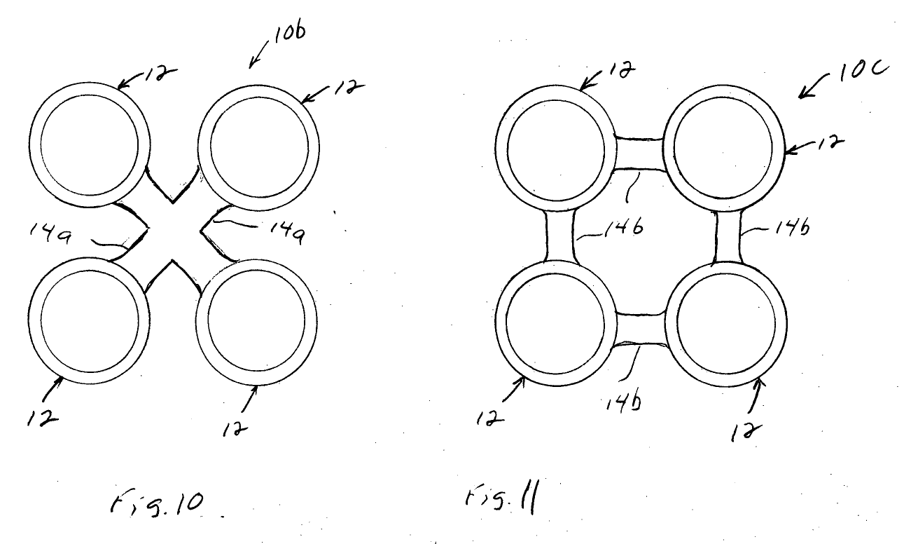

FIG. 10 depicts another alternative embodiment of the fixture 10 in the form of a fixture 10b. The fixture 10b has a web portion 14a formed differently than the web portion 14 of the fixture 10. The fixture 10b is otherwise substantially identical to the fixture 10. FIG. 11 depicts another alternative embodiment in the form of a fixture 10c. The fixture 10c has a web portion 14b configured differently than the web portion 14 of the fixture 10. The fixture 10c is otherwise substantially identical to the fixture 10.

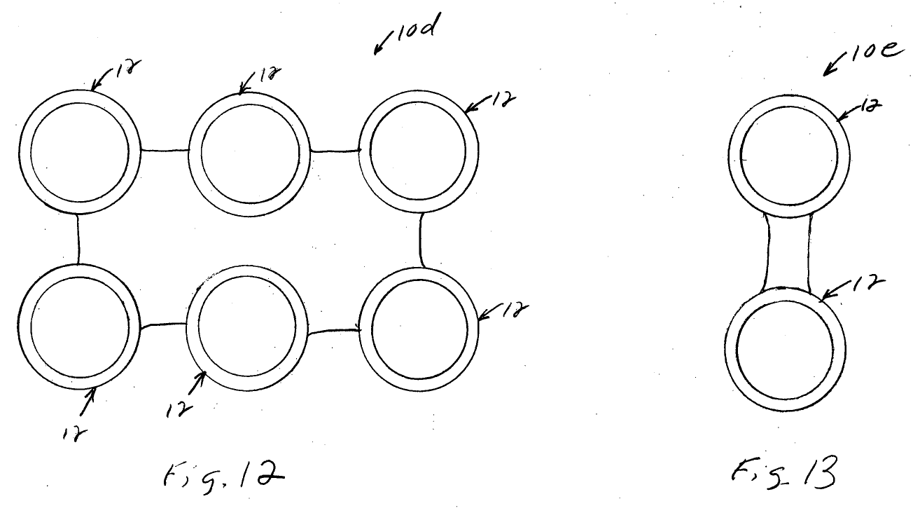

Other alternative embodiments of the fixture 10 can be formed with more, or less than eight of the cups 12. For example, FIG. 12 depicts a fixture 10d having six of the cups 12. FIG. 13 shows a fixture 10e having two of the cups 12.

What is claimed:

1. A fixture comprising a web portion, and a first and a second cup attached to the web portion, wherein: the first and second cups each have a portion capable of being received in respective first and second cavities formed in a molding apparatus; the first and second cups each define a volume for receiving respective first and second pickups of an end of arm tool; and a center to center spacing of the first and second cups is substantially equal to a center to center spacing of the first and second cavities so that the portions of the first and second cups can be received by the respective first and second cavities, and the first and second pickups can be received by the volumes defined by the respective first and second cups only when the end of arm tool is substantially aligned with the molding apparatus.

2. The fixture of claim 1, wherein the first and second cups each adjoin the web portion.

3. The fixture of claim 1, wherein the first and second cups and the web portion are unitarily formed.

4. The fixture of claim 1, wherein the portions of the first and second cups are sized to produce a predetermined nominal clearance between the portions of the first and second cups and a perimeter of the respective first and second cavities when the portions of the first and second cups are disposed in the respective first and second cavities.

5. The fixture of claim 4, wherein the volumes defined by the respective first and second cups are sized to produce a predetermined nominal clearance between perimeters of the volumes defined by the portions of the first and second cups and the respective first and second pickups when the first and second pickups are disposed within the respective first volumes defined by the respective first and second cups.

6. The fixture of claim 5, wherein the predetermined nominal clearance between the portions of the first and second cups and a perimeter of the respective first and second cavities is approximately 0.1 mm (0.004 inch), and the predetermined nominal clearance between perimeters of the volumes defined by the portions of the first and second cups and the respective first and second pickups is approximately 0.1 mm (0.004 inch).

7. The fixture of claim 1, wherein the first and second cups are substantially cylindrical.

8. The fixture of claim 1, wherein the first and second cups and the web portion are unitarily formed.

9. The fixture of claim 1, wherein the portions of the first and second cups project downward in relation to a lower surface of the web so that the portions of the first and second cups can extend into the respective first and second cavities when a lower surface of the web rests on an upwardly facing surface of the molding apparatus from which the first and second cavities extend.

10. The fixture of claim 1, further comprising a third and a fourth of the cups adjoining the web for receiving a third and a fourth of the pickups when the end of arm tool is substantially aligned with the molding apparatus.

11. A method for evaluating alignment of a molding apparatus and an end of arm tool, comprising placing a fixture on a surface of the molding apparatus so that a first and a second portion of the fixture become disposed in a respective first and second cavity of the molding apparatus, and determining whether a first and a second cup of the fixture can receive a respective first and second pickup of the end of arm tool if the end of arm tool is moved toward the fixture.

12. The method of claim 11 wherein determining whether a first and a second cup of the fixture can receive a respective first and second pickup of the end of arm tool if the end of arm tool is moved toward the fixture comprises observing a positional relationship between the first and second pickups and the respective first and second cups.

13. The method of claim 11 wherein determining whether a first and a second cup of the fixture can receive a respective first and second pickup of the end of arm tool if the end of arm tool is moved toward the fixture comprises moving the end of arm tool toward the fixture so that the first and second pickups are positioned proximate the respective first and second cups.

14. The method of claim 11 further comprising moving the end of arm tool toward the fixture so that the first pickup enters a volume defined by the first cup, and the second pickup enters a volume defined by the second cup.

15. The method of claim 11 wherein determining whether a first and a second cup of the fixture can receive a respective first and second pickup of the end of arm tool if the end of arm tool is moved toward the fixture comprises determining whether the first cup can receive the first pickup without substantial interference between the first cup and the first pickup, and determining whether the second cup can receive the second pickup without substantial interference between the second cup and the second pickup.

16. The method of claim 11 wherein placing a fixture on a surface of the molding apparatus so that a first and a second portion of the fixture become disposed in a respective first and second cavity of the molding apparatus comprises placing the fixture on the surface of the molding apparatus so that a third and a fourth portion of the fixture become disposed in a respective third and fourth cavity of the molding apparatus; and the method further comprises determining whether a third and a fourth cup of the fixture can receive a respective third and fourth pickup of the end of arm tool if the end of arm tool is moved toward the fixture.

17. The method of claim 11 wherein placing a fixture on a surface of the molding apparatus so that a first and a second portion of the fixture become disposed in a respective first and second cavity of the molding apparatus comprises placing the fixture on the surface of the molding apparatus so that a lower surface of a web portion of the fixture contacts the surface of the molding apparatus and the first and second portions project downwardly into the respective first and second cavities.

18. The method of claim 11 wherein placing a fixture on a surface of the molding apparatus so that a first and a second portion of the fixture become disposed in a respective first and second cavity of the molding apparatus comprises placing the fixture on the surface of the molding apparatus so that portions of the first and second cups become disposed in the respective first and second cavities.

19. method for positioning an arm of an injection molding system, comprising:
placing a fixture on a surface of a mold of the injection molding system so that a first and a second projection of the fixture extend into a respective first and second cavity formed in the mold; and
adjusting a position of the arm in relation to the mold until a first and a second pickup of an end of arm tool mounted on the arm can each enter a volume defined by the respective first and second cups without substantial interference between the first and second pickups and the respective first and second cups.

20. The method of claim 19 further comprising:
placing the fixture on a surface of a carryover inlay nest of the injection molding system so that first and second projections extend into a respective first and second cavity formed in the carryover inlay nest; and
adjusting a position of the arm in relation to the carryover inlay nest until the first and second pickups of the end of arm tool can each enter the volumes defined by the respective first and second cups without substantial interference between the first and second pickups and the respective first and second cups.
